(19) United States
(12) Patent Application Publication
(10) Pub. No.: US 2011/0234921 A1
(43) Pub. Date: Sep. 29, 2011

(54) Black-Level Compensation in Multi-Projector Display Systems

(76) Inventor: Victor Ivashin, Danville, CA (US)

(21) Appl. No.: 12/730,917

(22) Filed: Mar. 24, 2010

(51) Int. Cl. H04N 3/26

(52) U.S. Cl. 348/745; 348/E03.048

(57) ABSTRACT

In general, in one aspect, an embodiment features computer-readable media embodying instructions executable by a computer to perform a method comprising: receiving a pixel for an image to be projected upon a display surface by a plurality of projectors as a composite projection comprising a plurality of partially overlapping component projections each generated by one of the projectors; and selectively increasing a luminance value of the pixel based on the luminance value of the pixel, a location of the pixel in the composite projection, a predetermined black-point threshold value, and a predetermined black-level compensation value.

### FIELD

The present disclosure relates to projector-based display systems. More particularly, the present disclosure relates to black-level compensation for multi-projector display systems.

### BACKGROUND

Large displays can be created by combining the output from multiple projectors using an ever-increasing variety of technologies. Some systems demand rigid mounting requirements, manual alignment methods, and optical blending techniques. Others offer ad-hoc projector placement, electronic blending, and scalable configurations. Newer automated calibration systems typically require high-end camera(s) or similar measurement devices to gather the information necessary for computing and constructing necessary calibration datasets.

As the cost of commodity projectors has fallen and the average processing capabilities of PCs have increased, the capability to create inexpensive large-scale display solutions is ever more present. An example system employs a basic PC equipped with a GPU graphics card and two or more commodity projectors. Conventional technologies to calibrate such a system often demand high-end or specialized cameras to achieve automated results with high display quality. A high-resolution digital camera, for example, may be used to capture calibration images which are processed to compute data necessary for virtual realignment of each projector output to produce a unified display field.

Some systems support lower-cost capture hardware. Such systems obtain moderate-quality results with typical low-resolution, easily available, and inexpensive cameras (e.g. a webcam). Generally, such cameras do not provide enough dynamic range or resolution for conventional calibration methods to successfully achieve the finely-tuned luminance balancing and blending operations demanded for some display requirements. Thus these cameras cannot perform the functions necessary to provide accurate measurements of many automated parameters (i.e. pixel registration, black point, color response curves, etc.).

As a result, displays created by these low-cost devices often do not produce a high-quality output. To achieve better quality within such a system, methods are required to manually configure various optional settings. For example, pixel registration between two projectors is a core requirement for calibration and configuration of a unified display. Automation with a camera helps to remove many tedious and complex tasks. Where the output of multiple projectors overlaps on the display surface, edge blending becomes another basic calibration requirement. Color and luminance balancing, on the other hand, are optional settings that too can vastly improve display quality but may require very accurate measurements that are difficult to automate with camera devices of poor quality.

One projector parameter requiring compensation is the projector's black point. Nearly all projectors emit some amount of light even when all the pixels' output levels are set to “black.” This black point is visible when the display surface qualities and ambient lighting conditions are lower than the projector light intensity. In a darkened room, for example, a projector may create a black rectangle on the display wall. The black point relative to the projector's highest output level defines the contrast ratio for the device. In multi-projector displays the output of two or more projectors overlap, and the independent black points from each device combine to form a brighter region. If the black points of each device are quite low, or the ambient light conditions are higher than this setting, this effect may be unnoticeable. Generally, however, less-expensive projectors have lower contrast ratios and high black points, so the resulting effect is quite pronounced.

Technologies are continually being developed to lower projector black point and improve contrast ratios in new generations of projector hardware. However, in a large multi-projector display, combinations of overlapping devices compound the light troubles. At lower light levels in particular, the human eye is quite sensitive to changes in gray. With increased luminance, the eye adapts to the increased contrast and it becomes harder to notice the black point light leakage. Reducing contrast by increasing ambient light levels is one good way to reduce the effects of a high black point. However, this increase also reduces contrast. If the projector is made very bright to accommodate the revised ambient conditions, it is likely more prone to light leaks and the higher black point can remain visible.

### SUMMARY

In general, in one aspect, an embodiment features computer-readable media embodying instructions executable by a computer to perform a method comprising: receiving a pixel for an image to be projected upon a display surface by a plurality of projectors as a composite projection comprising a plurality of partially overlapping component projections each generated by one of the projectors; and selectively increasing a luminance value of the pixel based on the luminance value of the pixel, a location of the pixel in the composite projection, a predetermined black-point threshold value, and a predetermined black-level compensation value.

Embodiments of the computer-readable media can include one or more of the following features. In some embodiments, selectively increasing the luminance value of the pixel comprises: increasing the luminance value of the pixel only when the pixel is to be projected in a region where none of the component projections overlap. In some embodiments, selectively increasing the luminance value of the pixel further comprises: increasing the luminance value of the pixel only when the luminance value of the pixel is below the predetermined black-point threshold value. In some embodiments, selectively increasing the luminance value of the pixel comprises: increasing the luminance value of the pixel according to a function of the predetermined black-level compensation value. In some embodiments, the function of the predetermined black-level compensation value is a linear function. In some embodiments, the function of the predetermined black-level compensation value is a non-linear function. In some embodiments, the function of the predetermined black-level compensation value is a function of the predetermined black-point threshold value.

The details of one or more implementations are set forth in the accompanying drawings and the description below. Other features will be apparent from the description and drawings, and from the claims.

### DESCRIPTION OF DRAWINGS

FIG. 1 shows a multi-projector display system according to some embodiments.

FIG. 2 shows an example of this effect.

FIG. 3 is a graphical depiction of the black-level compensation disclosed herein.

FIG. 4 shows the result of selection of good black-level compensation values for the display of FIG. 2.

FIG. 5 shows a black-level compensation process for the projector platform of FIG. 1 according to some embodiments.

FIGS. 6A and 6B show example code for a GPU to adjust an input pixel according to a black-level compensation method.

FIGS. 7, 8 and 9 provide sample graphs illustrating the operation of the regulation methods of FIG. 6, respectively, for a single channel.

FIG. 10 shows one example interface that can be provided by projector platform 106.

The leading digit(s) of each reference numeral used in this specification indicates the number of the drawing in which the reference numeral first appears.

### DETAILED DESCRIPTION

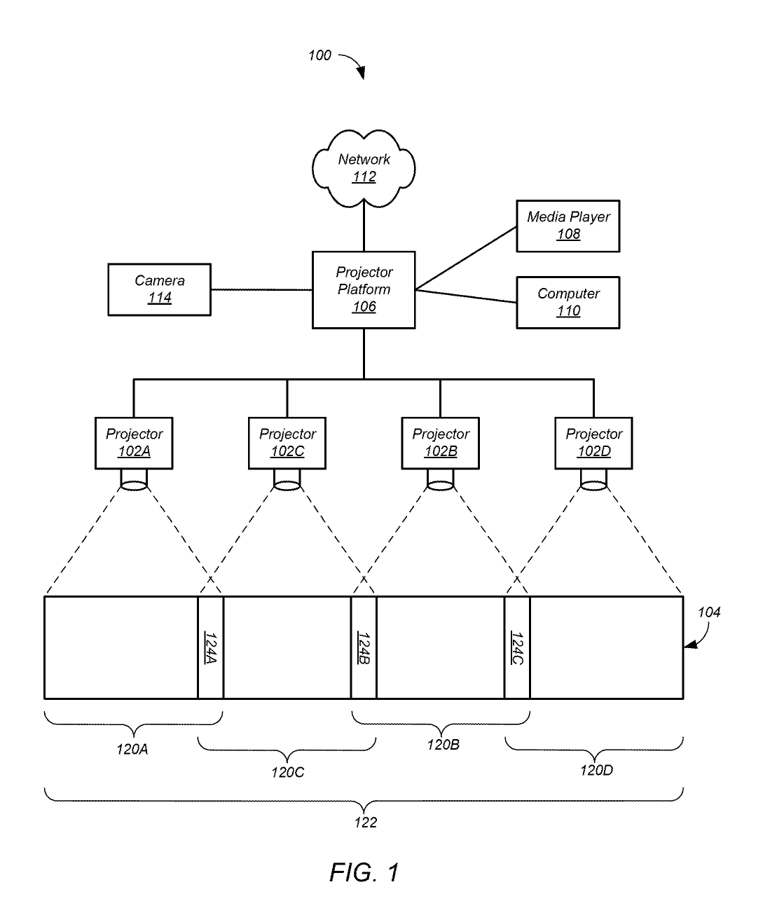

FIG. 1 shows a multi-projector display system 100 according to some embodiments. System 100 includes four projectors 102A-102D aimed at a display surface 104. Of course, other numbers of projectors 102 can be employed. Data is provided to projectors 102 by a projector platform 106, which can obtain source input from a media player 108, a computer 110, a source connected by a network 112 such as the Internet, and the like. For calibration, system 100 includes a digital camera 114.

In one embodiment, system 100 includes four projectors 102 and projector platform 106 is implemented as a personal computer (PC) configured with a central processing unit (CPU) and graphic processing units (GPU) providing four video outputs each connected to one of projectors 102. An optional capture card provides video input from sources such as computer 110, media player 108, and the like. Digital camera 114 is attached to the PC for the calibration process. After calibration, digital camera 114 may be removed or used as a media input device by projector platform 106.

Projectors 102A-102D produce respective component projections 120A-120D upon display surface 104. Together component projections 120A-120D form a single composite projection 122. Note that component projections 120 overlap in regions 124A-124C, which are referred to herein as “overlap regions.” The regions in composite projection 122 where component projections 120 do not overlap are referred to herein as “non-overlap regions.”

In overlap regions 124, multiple projectors contribute light for each pixel on display surface 104. Therefore, in overlap regions 124 the display can appear noticeably brighter than non-overlap regions. One common mitigating approach is electronic attenuation. Electronically attenuating the values of pixels in overlap regions 124 can allow for nearly seamless blending between component projections 120.

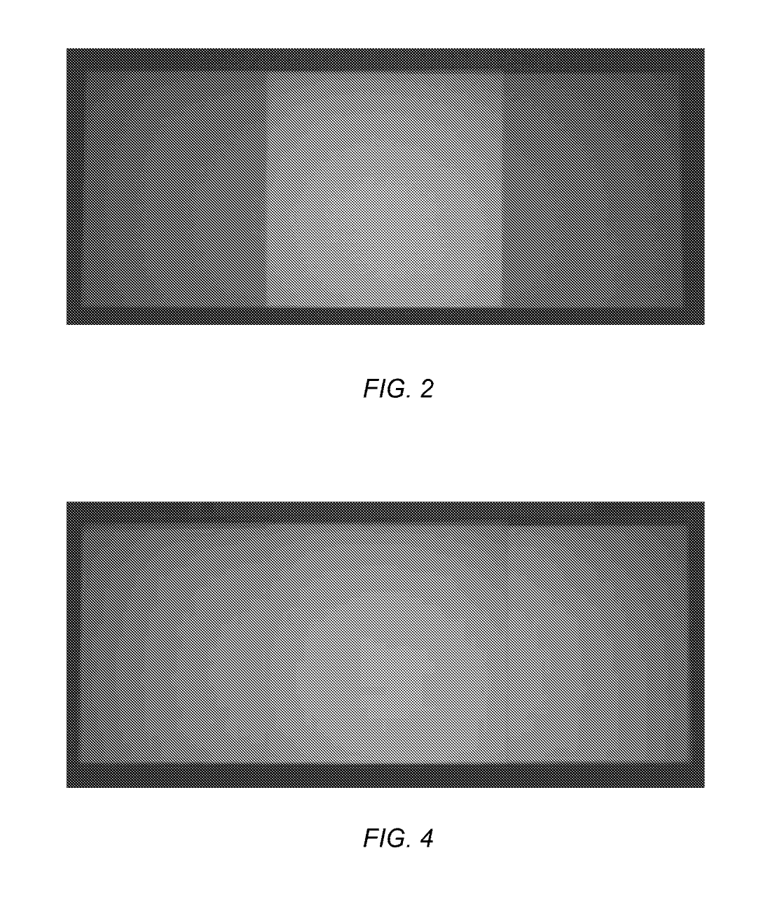

However, electronic attenuation is not effective at low luminance values. Even when a projector is set to output all black (e.g. digital RGB pixel value (0,0,0) at all pixel locations), some light is emitted or leaked by the projector. This effect occurs for a variety of technological reasons and varies by projector types, devices, and even within the display field of a single device. FIG. 2 shows an example of this effect. FIG. 2 shows a composite projection created by two projectors. In the overlap region of the composite projections, the pixels appear brighter than those in the non-overlapping regions. Note that each of the two projectors is emitting some output other than black. Worse, the overlap region contains the combined effect of this light leakage from both projectors and appears much brighter.

The level of light leakage and output is called the “black point” of the projector and represents the minimum color or darkest black level that can be electronically obtained by the device. Therefore, electronic means alone cannot lower the pixel values within the overlap region, as RGB (0,0,0) is the minimum signal value.

Embodiments disclosed herein add light electronically to non-overlap regions so that the output black level matches the light emitted in the overlap region. In particular, embodiments automatically increase base RGB pixel values output by each projector in their respective non-overlapping regions. This “black-level compensation” can be based on values selected interactively by users during calibration.

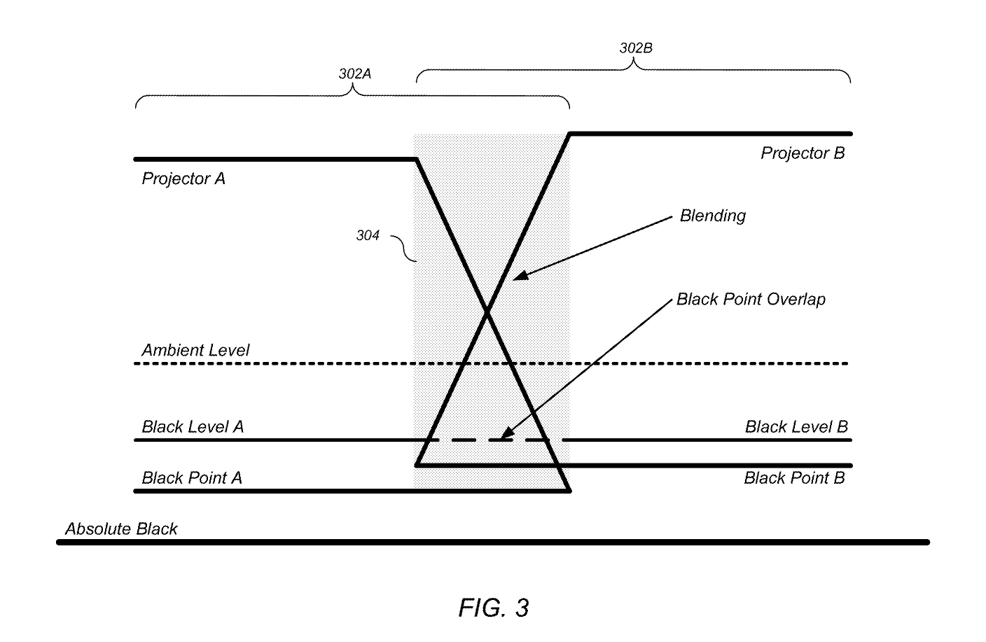

FIG. 3 is a graphical depiction of the black-level compensation disclosed herein. In FIG. 3, the horizontal axis represents space, while the vertical axis represents luminance. In FIG. 3, two projectors (Projector A and Projector B) create respective component projections 302A and 302B that overlap in an overlap region 304, which is shown as a gray rectangle. An absolute black level is not obtained by the projectors. Instead, Projector A and Projector B each output “black” at visible Black Point A and Black Point B. Where projections 302A and 302B overlap, a brighter Black Point Overlap is created. Raising the ambient light level in the room to somewhere above the Black Point Overlap, as indicated by the Ambient Level, would raise the black floor and the effects noticed would be replaced by diminished contrast in the display.

Projector A and Projector B have been calibrated such that computed intensity blending ramps control light output spatially across overlap region 304 according to blending functions (i.e. gamma settings, etc.). This process controls light output when pixel values increase in luminance. Therefore, the blending helps to keep overly bright regions from forming on the display surface.

To reduce the visibility of the non-uniform black points across the display, disclosed embodiments allow setting of black-level compensation values to attain Black Level A for Projector A and Black Level B for Projector B. These RGB vectors add light to non-overlap regions 302, producing a more unified display by lowering the contrast in non-overlap regions 302. FIG. 4 shows the result of selection of good black-level compensation values for the display of FIG. 2.

As can be seen by comparing FIGS. 2 and 4, electronic black-level compensation is very effective at low luminance levels. But at high luminance levels, the black level adjustments are no longer visible. At low luminance levels, small changes in pixel value can cause large visual effects in hue and brightness as the device output is not necessarily linear. As the source pixel values increase, added black level can shift the target color further within the non-overlapping region than appears among the blended values in the overlap region. Additionally, it can be seen that as luminance increases, so does contrast, so that black-level compensation becomes unnecessary. In some cases, bright banding and dramatic color shifts can occur. Therefore, various embodiments regulate the black-level compensation according to the luminance of the intended output as computed from the source input.

In some embodiments, a GPU in projector platform 106 (FIG. 1) provides a shader pipeline that executes a per-pixel manipulation of each projector output value. This pipeline allows for processing and adding black-level compensation values according to projector region in real time. The pipeline also provides regulation to control the amount of black-level compensation according to other factors such as function thresholds, source pixel luminance, and the like.

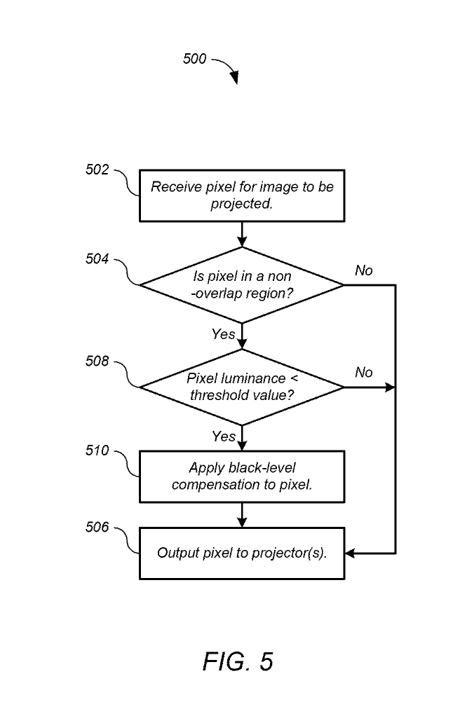

FIG. 5 shows a black-level compensation process 500 for projector platform 106 of FIG. 1 according to some embodiments. Although in the described embodiments, the elements of process 500 are presented in one arrangement, other embodiments may feature other arrangements, as will be apparent to one skilled in the relevant arts based on the disclosure and teachings provided herein. For example, in various embodiments, some or all of the steps of process 500 can be executed in a different order, concurrently, and the like.

Referring to FIG. 5, at 502, projector platform 106 receives a pixel for an image to be projected upon display surface 104 by a plurality of projectors 102 as a composite projection 122 comprising a plurality of partially overlapping component projections 120 each generated by one of projectors 102. Projector platform 106 then selectively increases one or more luminance values of the pixel based on the luminance value(s) of the pixel, the location of the pixel in composite projection 122, a predetermined black-point threshold value, and a predetermined black-level compensation value.

Pixels in overlap regions 124 are not compensated. Therefore, at 504, if the pixel is not in a non-overlap region, projector platform 106 outputs the pixel (without any black-level compensation) to projectors 102 at 506.

Furthermore, if the luminance of the pixel is sufficiently high, black-level compensation is unnecessary. This sufficiency is determined with respect to one or more predetermined threshold values referred to herein as “black-point threshold” values. In some embodiments, a single threshold value is used. In other embodiments, a different threshold value is used for each color channel. Therefore at 508, if the luminance of the pixel exceeds the black-point threshold value(s), projector platform 106 outputs the pixel (without any black-level compensation) to projectors 102 at 506.

At 510, black-level compensation is applied to pixels located in non-overlap regions and having luminance below the black-point threshold value(s). In particular, one or more luminance values of the pixel are increased according to a function of the predetermined black-level compensation value. In some embodiments, the function of the predetermined black-level compensation value is a linear function. In other embodiments, the function is a non-linear function. In other embodiments, the function can select among a set of chosen black-level compensation values determined at various RGB levels. In some embodiments, the function of the predetermined black-level compensation value is a function of the predetermined black-point threshold value. Projector platform 106 then outputs the black-level-compensated pixel to projectors 102 at 506.

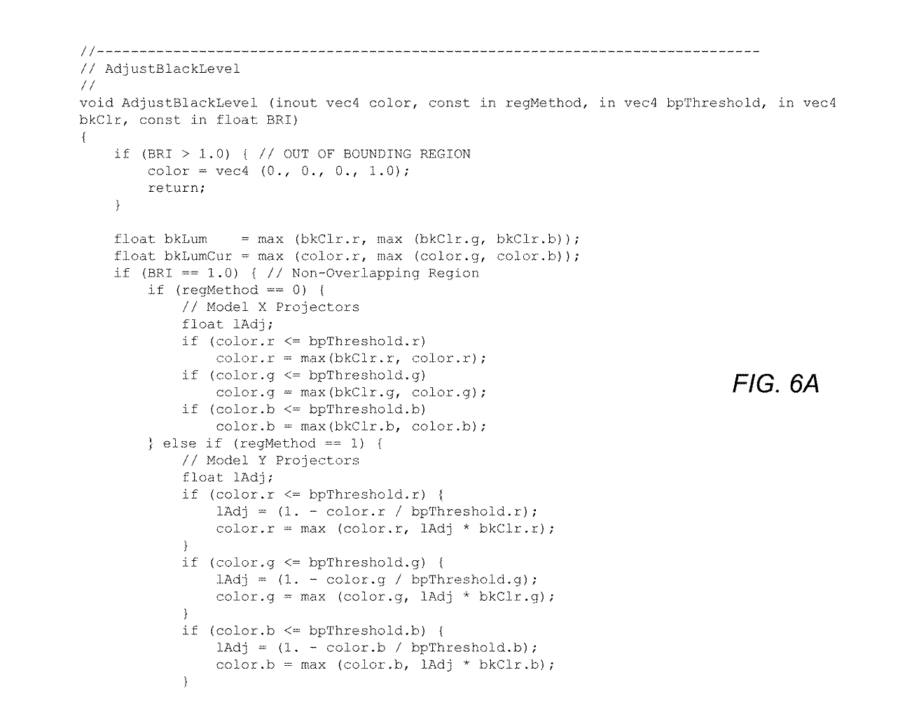

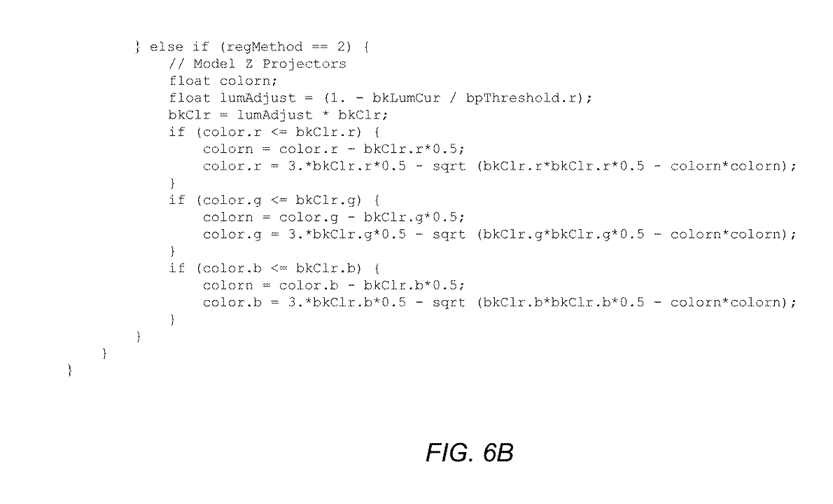

FIGS. 6A and 6B show example code for a GPU to adjust an input pixel (color) according to a black-level compensation method (regMethod), a black point threshold (bpThreshold), a black-level compensation value (bkClr) and a blending ramp intensity value (BRI) indicating whether the input color presents a pixel in an overlap region or a non-overlap region. The code includes respective regulation methods for three types of projectors (Model X Projectors, Model Y Projectors, and Model Z Projectors).

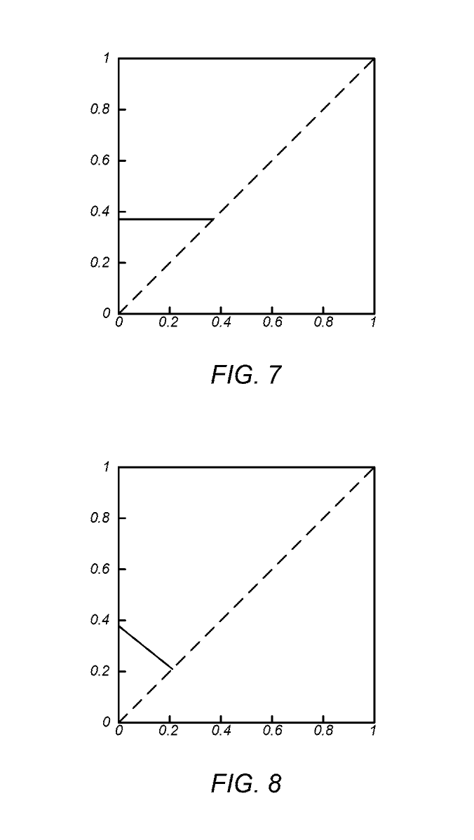

FIGS. 7, 8 and 9 provide sample graphs illustrating the operation of the three regulation methods of FIG. 6, respectively, for a single channel. In each graph, a threshold value of 0.4 and an abnormally high black-level compensation value of 96 (i.e. 96/255) are demonstrated. In each graph, the X-axis represents the input channel value prior to black-level compensation, and the Y-axis represents the output channel value after applying black-level compensation according to the regulation method. Note that the 8-bit channel values are normalized between 0.0 and 1.0 per common shader convention. In each graph, the dashed line represents the identity output (i.e. output equals input), while the solid line represents the modified output resulting from operation of the regulation method.

FIG. 7 shows a basic flat response result. With this method, the black-level compensation value is used for all colors until the input color is above the black-level compensation value.

FIG. 8 shows a more typical linear response result. With this method, the black-level compensation value is attenuated as the input color luminance increases. The slope is controlled by the black-level compensation value and a threshold.

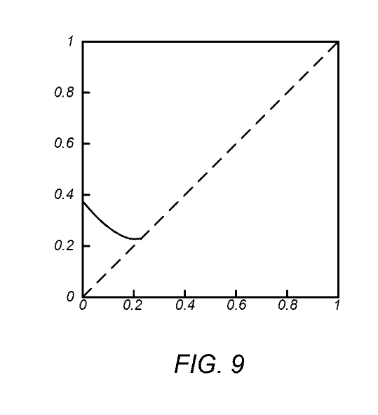

FIG. 9 shows a smoother curved response result. With this method, the black-level compensation value is attenuated as the input color luminance increases and gradually flattens as it approaches the intersection. The slope is controlled by the black-level compensation value and a threshold.

As mentioned above, users can interactively select values for black-level compensation during calibration. After a calibration method resolves the pixel registration and blending between displays, a playback method is enabled for configuring the display's black level settings elements. A user interface provides the controls used for setting adjustment. In one embodiment, this interface occupies some location within the output of the unified large display 104. In another embodiment, all or portions of the user interface are presented on an external display (e.g. a panel on projector platform 106) or on another device communicating with the projector platform via an API, a hardware interface or software extension (e.g. web browser interface).

One aspect of the interface is that it allows the user to manually select a projector region for modification. Note the regions, and the pixels they contain, are detected and determined by the calibration process. For example, the user can select the non-overlapping region of a projector (i.e. Projector A). Next, the interface provides a control to manipulate an output pixel value which will be displayed by the region as a black-level compensation setting. The interface is crafted to occupy a limited area and use a limited luminance range.

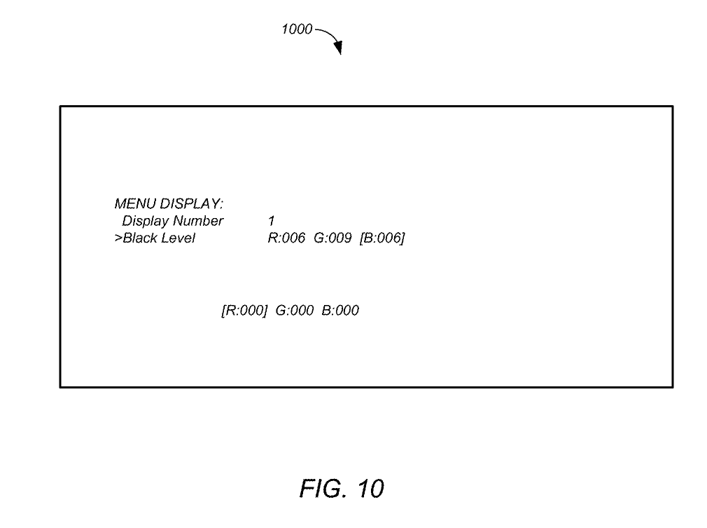

FIG. 10 shows one example interface 1000 that can be provided by projector platform 106. Settings made within this interface can be saved with calibration configuration data so that changes are preserved across media player launches. This example shows that a user has found a nicely matching black-level compensation value of R:006, G:009, B:006 for projector 1.

First, projector platform 106 configures the projectors to output “black” RGB pixel values (0,0,0). This will emit the darkest display field electronically capable by the display devices. Using the brighter overlap region as a guide, the operator adjusts the user interface elements using value selection and adjustment interface controls to control a pixel value associated with the selected region. As the value is adjusted, projector platform 106 causes its output to change in real time for the pixels in the indicated region. Observing the emitted light of the selected region and comparing it to the emitted light of the unchanged overlap region (emitting an unmodified RGB (0,0,0) output), the user finds a black-level compensation value which results in a pixel value that most closely approximates the overlap region output.

The user interface is configured with an option to show or hide the pixel value adjustment interface. For example, a keyboard key may toggle an interface indicator displaying the current pixel value setting. This provides the user with a completely blank display within which to compare the current settings. The user continues to select other regions, and adjusts the pixel values for each region, until the settings provide a more homogenous display.

It can be appreciated that projector setting can vary with lighting conditions. A theater mode may be desired at night while a brighter display mode should be made available during the day. Since recalibration is not required to adjust the black-level compensation with this method, time can be saved and quick adjustments made when necessary, for example due to changes in ambient lighting level.

Each red (R), green (G), and blue (B) channel component can be manipulated independently or together as a set. An interface status indicator identifies which channel is selected for adjustment or if adjustment will affect all channels. For example, those component values contained within square brackets mark the channel or channels selected, as shown below.

[R:### G:### B:###]—All channels are selected

[R:###] G:### B:###—Red channel is selected

R:### [G:###] B:###—Green channel is selected

R:### G:### [B:###]—Blue channel is selected

To change the current component selection, the LeftArrow-key or RightArrow-key may be pressed. These keys cycle the selection in the respective arrow direction among each channel and all channels as indicated by the square brackets notation. Pressing the R-key, G-key, or B-key directly selects the channel indicated by the chosen letter.

The component value(s) of the selected channel(s) can be adjusted in many ways to change the color. Pressing the UpArrow-key increases the channel(s) value(s) by 1. If a channel's new value will exceed 255 (maximum channel value), the new value is reset to 0. Pressing the DownArrow-key decreases the channel(s) value(s) by 1. If a channel's new value will be less than 0 (minimum channel value), the new value is be reset to 255. Pressing the Home-key sets the channel(s) value(s) to 255, while pressing the End-key sets the channel(s) values(s) to 0.

The PageUp-key and PageDown-key operate by setting a channel's value higher or lower, respectively. The new value is the value above or below the current channel's value as compared to the following list: 0, 32, 64, 96, 128, 192, 224, 255. For example, if the channel's value is 43 and the PageUp-key is pressed, the new value is 64 (the next higher value in the list). However, if the PageDown-key had been pressed, the new value is 32 (the next lower in the list). The list operates in a cyclic fashion such that the next higher value above 255 will be 0 and the next lower value below 0 is 255. When all channels are selected, only the first channel (red) is used for value comparison. The other channels are set equal to the first channel's new value.

Numbers 1, 2 and 3 represent the red, green, and blue channels respectively. Pressing one of these number keys selects the matching channel, sets the other channels values to 0, and then operates on the selected channel like the PageDown-key. Alternating among these keys can provide a quick method to set the respective channel to 255 (full color). The Backspace-key operates identically to the PageDown-key on all channels, regardless of the current channel selection. The current channel selection is left unchanged by this key.

Various embodiments can be implemented in digital electronic circuitry, or in computer hardware, firmware, software, or in combinations of them. Apparatus can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations have been described. Nevertheless, it will be understood that various modifications may be made without departing from the spirit and scope of this disclosure. Accordingly, other implementations are within the scope of the following claims.

What is claimed is:

1. Computer-readable media embodying instructions executable by a computer to perform a method comprising:
receiving a pixel for an image to be projected upon a display surface by a plurality of projectors as a composite projection comprising a plurality of partially overlapping component projections each generated by one of the projectors; and
selectively increasing a luminance value of the pixel based on the luminance value of the pixel, a location of the pixel in the composite projection, a predetermined black-point threshold value, and a predetermined black-level compensation value.

2. The computer-readable media of claim 1, wherein selectively increasing the luminance value of the pixel comprises:
increasing the luminance value of the pixel only when the pixel is to be projected in a region where none of the component projections overlap.

3. The computer-readable media of claim 2, wherein selectively increasing the luminance value of the pixel further comprises:
increasing the luminance value of the pixel only when the luminance value of the pixel is below the predetermined black-point threshold value.

4. The computer-readable media of claim 3, wherein selectively increasing the luminance value of the pixel comprises:
increasing the luminance value of the pixel according to a function of the predetermined black-level compensation value.

5. The computer-readable media of claim 4:
wherein the function of the predetermined black-level compensation value is a linear function.

6. The computer-readable media of claim 4:
wherein the function of the predetermined black-level compensation value is a non-linear function.

7. The computer-readable media of claim 4:
wherein the function of the predetermined black-level compensation value is a function of the predetermined black-point threshold value.
